(19) United States
(12) Patent Application Publication
(10) Pub. No.: US 2024/0132764 A1
(43) Pub. Date: Apr. 25, 2024

(54) LIGNIN-FORMALDEHYDE RESINS, RELATED COMPOSITIONS, AND RELATED METHODS

(71) Applicant: BOARD OF TRUSTEES OF MICHIGAN STATE UNIVERSITY, East Lansing, MI (US)

(72) Inventors: Mojgan Nejad, Okemos, MI (US); Mohsen Siahkamari, East Lansing, MI (US)

(21) Appl. No.: 18/275,060

(22) PCT Filed: Feb. 4, 2022
(86) PCT No.: PCT/US22/15210

§ 371 Date: Jul. 30, 2023

Related U.S. Application Data
(60) Provisional application No. 63/145,599, filed on Feb. 4, 2021.

(51) Int. Cl. C09J 197/00; B27N 1/02; B27N 3/00; C07G 1/00; C08G 8/24; C09J 161/06

(52) U.S. Cl. CPC C09J 197/005; B27N 1/0209; B27N 3/002; C07G 1/00; C08G 8/24; C09J 161/06; B27N 3/02

(57) ABSTRACT

The disclosure relates to adhesive compositions, including non-crosslinked resins and crosslinked/cured adhesives joining substrates, as well as related methods for making the compositions and articles. Compared to a conventional phenol (P) and formaldehyde (F) resin, the disclosed methods and compositions use lignin (L), formaldehyde (F), and optionally higher aldehydes (A) as corresponding replacements to provide an analog to a conventional PF resin with biobased reactants. Due to the differing reactivity of the LF components compared to the PF components, the initial condensation reaction between ortho-reactive sites in the lignin and the aldehyde is controlled to prevent gelation of the aqueous reaction mixture while reacting substantially all of the LF reactants to provide a non-crosslinked resin reaction product. The resin reaction product can then be cured at high temperature/high pressure conditions to provide a crosslinked adhesive, for example joining two substrates.

### CROSS REFERENCE TO RELATED APPLICATION

Priority is claimed to U.S. Provisional Application No. 63/145,599 (filed Feb. 4, 2021), which is incorporated herein by reference in its entirety.

### STATEMENT OF GOVERNMENT INTEREST

This invention was made with government support under 2018-67009-27900 awarded by the U.S. Department of Agriculture. The government has certain rights in the invention.

### BACKGROUND OF THE DISCLOSURE

### Field of the Disclosure

The disclosure relates to adhesive compositions and related methods for making the compositions and articles. The disclosed methods and compositions use lignin (L) and formaldehyde (F), optionally with higher aldehydes (A) such as dialdehydes, to provide an analog to a conventional phenol-formaldehyde (PF) resin with biobased reactants. The condensation reaction between ortho-reactive sites in the lignin and the formaldehyde is controlled to prevent gelation of the aqueous reaction mixture while reacting substantially all of the LF reactants to provide a non-crosslinked resin reaction product. The resin reaction product can then be cured to provide a crosslinked adhesive.

### Brief Description of Related Technology

Phenol formaldehyde (PF) is the most commonly used adhesive in the production of construction wood products like plywood, oriented strand board (OSB), laminated veneer lumber (LVL) and other engineered wood products. Accounting for more than 54% of worldwide consumption, North America is the largest market for PF resin in wood adhesive applications. Phenol formaldehyde resin is currently produced through condensation polymerization of fossil-derived compounds, specifically formaldehyde (made from methanol) and phenol (produced from benzene using the cumene process). Depending on the ratio of formaldehyde to phenol in the mixture and the type of catalyst used (basic or acidic), the final resin is either Resole (or Resol) or Novolac. Resole is the most commonly used phenolic resin in wood products today, and is produced from formaldehyde to phenol ratio of approximately 1.5:1.0 (or about 2.0-1.1 (formaldehyde):1.0 (phenol)) in the presence of an alkaline catalyst (NaOH or a caustic/ammonia combination). The corresponding thermosetting resin (Resole) forms a 3D network in a one step process and, when cured at about 120° C. to 175° C. for 3 to 5 minutes, depending on the type of adhesive and thickness of the resin wood layers (e.g., 3-, 5-, or 7-ply plywood), provides excellent water and chemical resistance to wood products, as well as high mechanical performance.

Different lignin types have been evaluated as phenol substitutes in the production of phenolic resin to be used in engineered wood products. Exterior grade plywood, oriented strand board (OSB), and laminated veneer lumber (LVL) are typically made using phenolic resin which is competitively priced and imparts excellent moisture as well as chemical resistance. Lignin is a naturally occurring polyphenolic compound that has the potential to be used as a phenol replacement in the production of phenolic resin. New extraction processes and the availability of lignin in large quantities from different resources including wood and annual crops provide a variety of different lignin types, particularly from agricultural sources.

Kalami et al. J. Appl. Polymer Sci., vol. 134, pp. 45124-45132 (2017) (Kalami 2017), and Kalami et al. Ind. Crops & Products., vol. 125, pp. 520-528 (2018) (Kalami 2018) are directed to adhesive compositions formed from lignin (L) and formaldehyde (F). Lignins from different sources (softwood, hardwood, or annual crop) and different isolation methods (kraft, organosolv, sulfite, soda, or enzymatic hydrolysis) were used as a phenol replacement in phenolic adhesive formulations.

### SUMMARY

In one aspect, the disclosure relates to a method for forming an adhesive composition, the method comprising: providing an aqueous reaction mixture comprising water, a lignin comprising aromatic hydroxyl groups and ortho-reactive carbon atoms relative to the hydroxyl groups, and an aldehyde comprising formaldehyde; wherein (i) a molar ratio of aromatic hydroxyl groups to aldehyde functional groups (initially) in the aqueous reaction mixture is in a range of 1:2 to 1:4 and/or (ii) a molar ratio of aldehyde-reactive sites (or carbon atoms) to aldehyde functional groups (initially) in the aqueous reaction mixture is in a range of 1:1.5 to 1:3.5; adding a base catalyst in a controlled manner to the aqueous reaction mixture, thereby catalyzing a condensation reaction between the lignin and the aldehyde while maintaining a viscosity of aqueous reaction mixture below a gelation point of the aqueous reaction mixture; and continuing the condensation reaction between the lignin and the aldehyde to form a resin reaction product while maintaining the viscosity of aqueous reaction mixture below the gelation point of the aqueous reaction mixture until a completion point is reached, wherein, at the completion point, at least some unreacted ortho-reactive carbon atoms remain, at least some methylol functional groups have been formed by the condensation reaction and are present in the resin reaction product.

Suitably, the resin reaction product is not crosslinked at the completion point. Thus, while aldehyde groups and ortho-reactive carbon atoms have reacted to form (unsubstituted or substituted) methylol, alkylol, or hydroxyglyoxylated groups at the ortho sites of the aromatic hydroxyl groups in the lignin, a networked or crosslinked thermoset polymer with (unsubstituted or substituted) methylene, alkylene, glyoxylene, etc. groups bridging or linking ortho sites of two lignin aromatic groups has not yet formed. A networked or crosslinked structure forms after curing. Accordingly, the aqueous reaction medium is suitably substantially free from solid or precipitate material at the completion point (e.g., less than 0.1 or 0.01 wt. % solids not dissolved or otherwise in solution).

Various refinements of the disclosed methods, resin compositions and adhesive compositions are possible.

In a refinement, providing the aqueous reaction mixture comprises: providing a lignin solution comprising the lignin in solution in the water at a pH value of at least 12 (e.g., including NaOH or other base catalyst initially); and adding the aldehyde to the lignin solution to form the aqueous reaction mixture. The pH value more generally can be in a range of 10.5 to 14 or 12 to 13, such as at least 10.5, 11, or 12 and/or up to 12, 12.5, 13, or 14. In a further refinement, the lignin solution contains an amount of water in a range of 100% to 150% (e.g., at least 100 or 110% and/or up to 110, 120, 130, 140, or 150%) of the minimum amount of water required to dissolve the lignin at the pH value of the lignin solution.

In a refinement, the aqueous reaction mixture at the completion point has a viscosity in a range of 200 cP to 1500 cP measured at a constant shear rate of 1000 s⁻¹ and 25° C.; and/or the aqueous reaction mixture at the completion point has a solids content in a range of 15 wt. % to 45 wt. %. More generally, the viscosity can be at least 200, 300, 400, 500, 600, 800, or 1000 cP and/or up to 600, 700, 900, 1200, or 1500 cP. In embodiments, the solids content can be at least 15, 20, 25, or 30 wt. % and/or up to 30, 35, 40, or 45 wt. %. The foregoing amounts for solids content can similarly apply to the concentration of the resin reaction product in the aqueous reaction mixture, such as at the completion point.

In a refinement, the aqueous reaction mixture at the completion point contains 1 wt. % or less free (unreacted) formaldehyde. While free or unreacted formaldehyde in a final cured adhesive is generally undesirable in the final cured adhesive due to possible emission concerns, etc., minor amounts of free or unreacted formaldehyde in the resin (e.g., aqueous reaction mixture containing the resin reaction product after initial condensation) as acceptable and can react to form crosslinks during eventual curing in the adhesive. In embodiments, the aqueous reaction mixture at the completion point can contain at least 0.01 or 0.1 wt. % and/or up to 0.3, 0.5, 0.7, 1, 2, 3, 4, or 6 wt. % free or unreacted formaldehyde. Suitably, substantially all of the formaldehyde has been consumed after adhesive curing, such that the final cured adhesive contains not more than 0.001, 0.01, 0.1, 0.2, 0.3, or 0.5 wt. % free or unreacted formaldehyde.

In a refinement, the method comprises forming the resin reaction product at a reaction temperature in a range from 40° C. to 95° C. or 65° C. to 85° C. while avoiding gelation and cross-linking.

In a refinement, the lignin is an unmodified kraft softwood lignin.

In a refinement, the lignin is derived from a biomass selected from the group consisting of hardwoods, softwoods, grasses (e.g., agricultural residues), and combinations thereof.

In a refinement, the lignin is isolated from an extraction process selected from the group consisting of Kraft extraction, soda extraction, organosolv extraction, enzymatic hydrolysis extraction, ionic liquid, extraction, sulfite extraction, and combinations thereof. In various embodiments, the lignin, prior to reaction and/or incorporation into the aqueous reaction mixture, suitably has some or all of the following properties: a molecular weight in a range of 500 to 50000, 500 to 20000, or 3000 to 5000; a polydispersity in a range of 1.2 to 10, 1.2 to 5, or 2 to 4; an aliphatic hydroxyl content in a range of 1 to 5 mmol/g, 1 to 4 mmol/g, or 1 to 3 mmol/g; a phenolic or aromatic hydroxyl content in a range of 1 to 6 mmol/g, 2 to 6 mmol/g. or 3 to 6 mmol/g; and a total hydroxyl content in a range of 3 to 9 mmol/g or 4 to 7 mmol/g.

In a refinement, the lignin (e.g., as initially added to the aqueous reaction mixture prior to condensation reaction) has at least one of the following properties: a weight-average molecular weight of 2000 or less; a weight-average molecular weight of 1200 or more; a polydispersity of 2.0 or less; a polydispersity of 1.5 or more; and at least 50% or at least 60% of the aromatic hydroxy groups have at least 1 ortho-reactive carbon relative to the hydroxy group (e.g., 1 or 2 ortho-reactive carbons).

In a refinement, the lignin (e.g., as initially added to the aqueous reaction mixture prior to condensation reaction) comprises aromatic ether groups and ortho-reactive carbon atoms relative to the ether groups, for example in condensed phenolic residues of the lignin. The aromatic ether groups can be represented by Ar—O—Ar, where Ar represents base aromatic or phenolic units on the lignin. For example, the lignin can contain 0.05 to 1.5 mmol/g or 0.1 to 1 mmol/g of condensed phenolic residues, for example at least 0.05, 0.1, 0.15, 0.2, 0.3, or 0.5 mmol/g and/or up to 0.2, 0.4, 0.6, 0.8, 1, 1.2 or 1.5 mmol/g condensed phenolic residues, which in turn can include ortho-reactive carbon atoms.

In a refinement, the aqueous reaction mixture (e.g., as originally provided) is free from phenol and/or aldehydes having at least 2 carbon atoms and at least 1 aldehyde functional group (—CHO).

In a refinement, the aqueous reaction mixture comprises a higher aldehyde having at least 2 carbon atoms and at least 1 aldehyde functional group (—CHO). The higher aldehyde can have 2 to 50 carbon atoms and 1 to 4 aldehyde functional groups. In a particular refinement, 5% to 95% of the aldehyde functional groups in the aqueous reaction mixture are from the formaldehyde; and 5% to 95% of the aldehyde functional groups in the aqueous reaction mixture are from the higher aldehyde. In a particular refinement, 40% to 80% of the aldehyde functional groups in the aqueous reaction mixture are from the formaldehyde; and 20% to 60% of the aldehyde functional groups in the aqueous reaction mixture are from the higher aldehyde.

In a refinement, the aqueous reaction mixture comprises phenol. In a particular refinement, 70% to 99% of the aromatic hydroxyl groups in the aqueous reaction mixture are from the lignin; and 1% to 30% of the aromatic hydroxyl groups in the aqueous reaction mixture are from the phenol.

In a refinement, the method further comprises adding the aldehyde aqueous reaction mixture in a controlled manner and in the presence of at least some base catalyst, thereby catalyzing a condensation reaction between the lignin and the aldehyde while maintaining a viscosity of aqueous reaction mixture below a gelation point of the aqueous reaction mixture.

In a refinement, the resin reaction product or the aqueous reaction mixture at the completion point can have a pH of 8 to 12 or 10 to 11. For example, the pH value can be at least 8, 9, 9.5 or 10 and/or up to 10.5, 11, 11.5, or 12.

In a refinement, the resin reaction product or the aqueous reaction mixture at the completion point can have an alkalinity value of 1.5% to 7%, 1% to 5%, or 2% to 3%. For example, the alkalinity value can be at least 1, 1.5, or 2% and/or up to 2, 2.5, 3, 4, 5, 6, or 7%.

In a refinement, the resin reaction product or the aqueous reaction mixture at the completion point can have a gelation time of 2 min to 50 min, 4 min to 50 min, or 4 min to 30 min. For example, the gelation time can be at least 2, 4, 5, 6, 8, 10, 12, 15, 20, or 30 min and/or up to 6, 9, 12, 15, 18, 21, 25, 30, 35, 40, or 50 min.

In a refinement, the molar ratio of aromatic hydroxyl groups to aldehyde functional groups (initially) in the aqueous reaction mixture is in a range of 1:3 to 1:4.

In a refinement, the method further comprises: adding one or more adhesive components to the aqueous reaction mixture at or after the completion point, the adhesive components being selected from the group consisting of fillers, further catalyst, and further water; and continuing the condensation reaction between remaining unreacted ortho-reactive carbon atoms and the unsubstituted or substituted methylol or hydroxyoxylated groups in the resin reaction product, thereby forming a crosslinked adhesive composition (e.g., networked or otherwise cured product). As described above, the unsubstituted or substituted methylol groups result from the initial condensation reaction between aldehyde groups of the aldehyde reactant and the ortho-reactive carbon atoms of the lignin reactant. During the curing portion of the condensation reaction, any unreacted aldehyde functional groups also can react, for example by reacting with a substrate, reacting to form further unsubstituted or substituted methylol groups (e.g., which can in turn condense to form a crosslink), etc. The fillers are not particularly limited and can include polysaccharides such as starches, and/or lignocellulosic biomass such as woody fibers (e.g., wood flour, alder bark, etc.) The fillers can perform a variety of functions, for example providing a thickener for the adhesive composition prior to curing, an absorbent for excess water in the adhesive composition, a mechanical reinforcement for the cured adhesive composition, etc. In some embodiments, reactive functional groups on the fillers can react with the remaining aldehyde groups during curing.

In a further refinement, at least one adhesive component is the further catalyst, and the further catalyst is in solid form when added to the aqueous reaction mixture.

In a further refinement, at least one adhesive component is the further catalyst, and the further catalyst is present in an amount in a range of 2 wt. % to 6 wt. % after addition of (all of) the adhesive components. In embodiments, the further catalyst is present or added in an amount of at least 2, 2.5, or 3 wt. % and/or up to 3, 4, 5, or 6 wt. % relative to the adhesive composition (e.g., after all adhesive components have been added to the resin and prior to curing).

In a further refinement, at least one adhesive component is the further catalyst, and the further catalyst is in solid form when added to the aqueous reaction mixture; at least one adhesive component is the further water; at least one adhesive component is a filler; and the further water and the further catalyst are added to the aqueous reaction mixture separately from and before the filler.

In a further refinement, the method further comprises continuing the condensation reaction at a reaction temperature in a range from 100° C. to 200° C., 120° C. to 180° C., or 130° C. to 180° C. while cross-linking.

In a further refinement, the method further comprises continuing the condensation reaction when the aqueous reaction mixture is in contact with one or more substrates (e.g., two or more substrates to be joined by the final cured adhesive). The substrate is not particularly limited and generally can be formed from any material. Suitably, the substrate is formed from wood or otherwise includes wood as a component of the substrate surface bonded with the adhesive.

In another aspect, the disclosure relates to a method for forming an adhesive composition, the method comprising: providing a resin reaction product formed according to any of the disclosed embodiments (e.g., by performing the initial condensation reaction to the non-crosslinked completion point); adding one or more adhesive components to the aqueous reaction mixture containing the resin reaction product, the adhesive components being selected from the group consisting of fillers, further catalyst, and further water; and continuing the condensation reaction between remaining unreacted ortho-reactive carbon atoms and the unsubstituted or substituted methylol groups in the resin reaction product, thereby forming a crosslinked adhesive composition.

In another aspect, the disclosure relates to an adhesive or resin composition formed by any of the disclosed embodiments including an uncrosslinked resin reaction product (e.g., a resin composition formed at the completion point of the initial reaction and that can be used in a subsequent adhesive formulation). As used herein, a resin composition can refer to an adhesive composition according to the general disclosure, prior to addition of adhesive components such as fillers, further catalyst, and further water to the aqueous reaction mixture containing the uncrosslinked resin reaction product, for example at the completion point.

In another aspect, the disclosure relates to a crosslinked adhesive composition formed by any of the disclosed embodiments (e.g., fully cured/crosslinked resin composition after addition of other adhesive components, for example in the form of an article having one or more substrates with the crosslinked adhesive composition coated thereon, such as joining two or more substrates).

While the disclosed methods, compositions, and articles are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 illustrates an article according to the disclosure in which the crosslinked adhesive composition is a coating on a substrate.

FIG. 2 illustrates an article according to the disclosure in which the crosslinked adhesive composition is an adhesive joining two substrates.

### DETAILED DESCRIPTION

The disclosure relates to adhesive compositions, including non-crosslinked resins and crosslinked/cured adhesives joining substrates, as well as related methods for making the compositions and articles. Compared to a conventional phenol (P) and formaldehyde (F) resin, the disclosed methods and compositions use lignin (L) and formaldehyde (F), optionally with higher aldehydes (A), as corresponding replacements to provide an LF analog to a conventional PF resin with one or more biobased reactants. In general, however, there are three major obstacles in using lignin as a phenol replacement in a corresponding composition/adhesive: 1) low reactivity, 2) high molecular weight, and 3) high polydispersity.

Low reactivity of lignin in comparison with phenol is due to the fact that phenol has three available positions for reaction with an aldehyde such as formaldehyde (one para and two ortho positions), whereas in lignin macromolecules, the para position typically participates in intramolecular linkages and so is not available for reaction. Furthermore, if the starting material is syringyl, guaiacyl, or hydroxyphenyl lignin, there are none, one, or two ortho positions available for reaction with formaldehyde, respectively. Therefore, hardwood lignin that contains a high concentration of syringyl lignin with two ortho positions filled with methoxyl (—OCH₃) groups is less suitable for phenolic resin production. Softwood lignin with a higher concentration of guaiacyl units that has at least one free ortho position is better suited than hardwood, but still less reactive than grass lignins. In contrast, lignin samples having a high concentration of hydroxyphenyl lignin units are particularly suitable a phenol replacement, because the hydroxyphenyl lignin has two free ortho positions for reaction with an aldehyde-functional co-reactant.

The second problem in using lignin as a phenol substitute is the complex 3D structure of lignin and its high molecular weight. The higher the molecular weight, the lower the reactivity of lignin toward any chemical reactions. The 3D structure of lignin also limits the accessibility of reactants. Therefore, a lignin to be used as a phenol replacement suitably has a relatively low molecular weight, for example below 1000 or below 5000. The low molecular weight depends on the extraction process and the number of linkages broken during the isolation process.

Molecular heterogeneity is a third challenge to applications of lignin and other natural polymers. For instance, lignin, unlike many synthetic polymers, has relatively high polydispersity, or in other words, contains a wide range of molecular sizes. The lower the polydispersity, or having a more consistent molecular size, facilitates the formation of more reproducible resins with predictable properties. When considering reactions between phenols with aldehydes, the most active sites in the phenolic reactant are the para and then ortho positions. The para positions in lignins are sterically hindered and not free for subsequent reactions; therefore, lignins having a comparatively high fraction of free ortho positions are preferred. In this regard, hydroxyphenyl lignin is a particularly suitable lignin component/source, followed by guaiacyl lignin from coniferous trees (softwood). It is further preferable to use a lignin feedstock having a comparatively low molecular weight and narrow molecular weight distribution (i.e., a low polydispersity). Given similar chemistry, a lower molecular weight increases the reactivity of the lignin, and a lower polydispersity improves the homogeneity of the corresponding resins (i.e., which thus have more reproducible properties).

The present disclosure addresses problems in forming lignin-formaldehyde (LF) adhesives using alternative components relative to conventional phenol-formaldehyde (PF) adhesives. Due to the differing reactivity of the LF components compared to the PF components, the initial condensation reaction between ortho-reactive sites in the lignin and the aldehyde is controlled to prevent the gelation of the aqueous reaction mixture while reacting substantially all of the LF reactants to provide a non-crosslinked resin reaction product. Suitably, the molar ratio of L:F, in particular the ratio of phenolic hydroxyl groups with reactive sites (e.g., in L) to aldehyde groups (e.g., in F or in all aldehyde-containing species combined) is selected to reflect a substantial molar excess of aldehyde functionalities. The resin reaction product can then be cured at high temperature/high pressure conditions to provide a crosslinked adhesive, for example joining two substrates. The biobased LF resin can be used to formulate phenolic adhesives, coatings, and elastomers. The LF adhesive has a similar dry adhesion strength as compared to a PF adhesive. The LF adhesive can be used, for example, in the manufacturing of plywood, particleboard, fiberboard, oriented strand board (OSB), other engineered wood products, and mass timber products.

More generally, the disclosure relates to the use of commercially available lignins to formulate biobased phenolic resins and adhesives for application in engineered wood products (e.g., plywood, OSB, and LVL). Relative to conventional PF resin/adhesive formulations, several techniques can be applied during the formulation of high-performance lignin-formaldehyde (LF) resins and adhesives in which 100% of phenol is replaced with lignin: (1) Lignin is preferably completely dissolved first in an alkaline solution (e.g., using NaOH; pH>12) prior to formaldehyde addition. (2) The molar ratio of lignin to formaldehyde (L:F; or total phenolic hydroxyl groups to total aldehyde groups) is preferably 1.0:2.0-4.0, 1.0:2.5-4.0, or 1.0:3.0-4.0, which significantly higher degree of aldehyde functionality than the commonly used in PF resins with a molar ratio of P:F of about 1.0:1.2-1.5. (3) During resin formation, the base catalyst (e.g., NaOH solution) is preferably carefully added to the resin (e.g., in two or more steps) to avoid the gelation of the resin. (4) The pH of the final resin is preferably above 10. (5) During adhesive formulation, instead of using adding an aqueous solution of additional base catalyst (e.g., 50% solution of NaOH), solid base catalyst (e.g., NaOH such as in flake or particle form) is preferably added to the resin to provide an adhesive that can achieve higher adhesion strengths (e.g., at/above 4.6 MPa).

An important consideration in resin formulation is to find the proper molar ratio of formaldehyde (or aldehyde functionality) to lignin (or phenolic hydroxyl functionality). Using phosphorus nuclear magnetic resonance spectroscopy data (³¹P NMR), which is the most reliable technique to calculate the phenolic hydroxyl content of lignin, is the best way to start, but not sufficient. This is due to the fact that depending on the source of biomass (hardwood, softwood or annual crops) and the isolation process (kraft, soda, sulfite, organosolv, ionic liquid, and hydrolysis) properties of lignin vary significantly. One key variation is the quantity of different lignin aromatic hydroxyl groups. For instance, grass lignin contains a higher amount of hydroxyphenyl groups (H-lignin), with two free ortho positions on the aromatic ring, is the most reactive lignin precursor toward formaldehyde. While softwood lignin with higher guaiacyl content (G) has relatively lower reactivity toward formaldehyde because there is only one free ortho position in G-lignin. The reactivity of hardwood lignin with formaldehyde is even lower, because hardwood lignin contains a higher amount of syringyl units (S-lignin). Both ortho positions are occupied with methoxy groups. Thus it is important to know not just the amount of phenolic hydroxyl groups of lignin but also the type of aromatic hydroxyl groups (S, G, and H). Using an excessively high amount of formaldehyde during resin formulation can result in resin with an excessively high formaldehyde emission (e.g., in addition to increasing the rate side reactions). Using an excessively low amount pf formaldehyde during resin formulation can result in an adhesive with low adhesion performance (e.g., as a result of low cross-linking density). Thus, it is desirable to identify a balanced amount of F (or total aldehyde) that, for a given amount, type, and distribution of L (e.g., with respect to type of aromatic hydroxyl groups), can advantageously provide a resin without gelation while retaining sufficient reactive groups (e.g., methylol and/or ortho-reactive phenolic or aromatic groups) react during adhesive curing, thus reacting substantially all reactive L and/or F groups for a strong adhesive bond without emission of unreacted F.

An appropriate amount of aldehyde or aldehyde functional groups (e.g., from formaldehyde and any optional higher aldehydes) in the initial aqueous reaction mixture can be selected in the preparation of the resin so that it produces a resin with desired properties (e.g., viscosity, solids content) while, on the other hand, the amount of free formaldehyde and/or higher aldehydes remaining in the resin and in the final adhesive is not excessive. Therefore, in addition to or as an alternative to selecting the aldehyde content in initial aqueous reaction mixture based on the total phenolic hydroxyl content, the aldehyde of formaldehyde content can be selected relative to the number (or moles) of available aldehyde-reactive sites (i.e., sites in lignin or phenol that are reactive with formaldehyde or other aldehyde reactant). Such aldehyde-reactive sites include ortho-reactive carbon atoms in aromatic/phenolic hydroxyl groups in lignin or a phenol co-reactant, as well as para-reactive carbons atoms in a phenol co-reactant. For example, an H-lignin residue includes two aldehyde-reactive sites per aromatic/phenolic hydroxyl group (i.e., two ortho-reactive carbon atoms), and a G-lignin residue includes one aldehyde-reactive site per aromatic/phenolic hydroxyl group (i.e., one ortho-reactive carbon atoms). Similarly, a phenol molecule included as an optional co-reactant to supplement lignin includes three aldehyde-reactive sites for its single aromatic/phenolic hydroxyl group, namely including the two unsubstituted carbon atoms in ortho position relative to the hydroxyl group and the one unsubstituted carbon atom in para position relative to the hydroxyl group (i.e., which is reactive in phenol but substituted in G,S, and H-lignin residues). Suitably a molar ratio of aldehyde-reactive sites (or carbon atoms) to aldehyde functional groups (initially) in the aqueous reaction mixture is about 1:2, for example in a range of 1:1.5 to 1:3.5, 1:1.6 to 1:3, or 1:1.7 to 1:2.5.

Additionally, looking closely at the lignin structure shows that there are a number of aromatic rings with potential active sites (e.g., free ortho-position carbon atoms), that do not show up in ³¹P NMR spectra because they are linked to other lignin monomers (e.g., condensed phenolic residues or ether linkages) and do not have free phenolic hydroxyl groups to react with the ³¹P NMR reagent. Thus, selecting the amount of formaldehyde needed based only on the total phenolic hydroxyl content of lignin (measured by ³¹P NMR) and/or phenolic hydroxyl ortho-reactive sites could also result in low-performance resin. The ³¹P NMR spectra only show the amount of free phenolic hydroxyl groups in lignin, not the aromatic rings linked to another lignin monomer (e.g., condensed phenolic residues or ether linkages), which also can include aldehyde-reactive sites at free carbon atoms in ortho-position to such (ether-linked) aromatic rings. Thus, the L:F molar ratio that is selected for resin formation and that uses the phenolic hydroxyl groups in the lignin as a relative basis for aldehyde content is generally higher than a P:F ratio suitable for typical PF resins.

In the LF resin, the base catalyst (e.g., NaOH solution) plays two roles, serving both as a solvent to dissolve the lignin and as a catalyst for initiating the lignin and formaldehyde reaction (e.g., as a resole-type resin). While in adhesive formulation, base compounds such as NaOH are used only as a catalyst. In typical PF glue mix or adhesive formulations, the resin industry recommends the use of 3% NaOH (50% aqueous solution) as base catalyst additive to the PF resin to form the corresponding PF adhesive. In lignin-based adhesives according to the disclosure, the base catalyst (e.g., NaOH) added to the LF resin is preferably in a solid form, such as a flake or particle form. Using base catalyst flake or solid improves the adhesion strengths of lignin-based phenolic (LF) adhesives to wood. In contrast, a lignin-based adhesive formulated with a 3% solution of NaOH (50 wt. %) can fail the lap shear test. For example, when using LF resins formed according to the disclosure to make a corresponding LF adhesive, adhesives in which a liquid base catalyst solution is added to the LF resin can have a lower adhesion strength (e.g., a failing a lap shear test) as compared to adhesives in which a solid phase base catalyst is added to the LF resin (e.g., passing a lap shear test). The LF resin usually has a much lower solid content than that of a PF resin. This is due to the fact that, unlike phenol, lignin is solid and is preferably dissolved in a base catalyst solution prior to the addition of formaldehyde. Thus, having a higher concentration of catalyst in the adhesive formulation step (e.g., as a result of solid-phase base addition or a larger volume of concentrated aqueous base solution) can potentially improve the reaction of free formaldehyde and methylol (Ar—CH₂—OH) groups of (LF) adhesive to form a chemical bond with the lignin in the wood surface. For example, the amount of base catalyst added to a resin formulation to form a corresponding adhesive formulation can be about 3 wt. % (e.g., 3 wt. % of solid base added, 6 wt. % of 50 wt. % aqueous solution of base, etc.).

In order to obtain lignin-based resin with a solid content comparable to PF resin, the amount of initial base (e.g., NaOH) used for the dissolution of lignin is suitably minimized. For example, the amount of aqueous base catalyst solution (e.g., 1M NaOH) can be selected to be the minimum amount that will essentially completely dissolve the lignin to be added to the aqueous reaction mixture while also obtaining the desired pH of the aqueous reaction mixture (e.g., about pH 12 or in a range of 10.5 to 14). Furthermore, reducing the amount of this base catalyst solution solvent for the lignin can result in a significant increase in viscosity, so that the final lignin-based resins have a viscosity quite comparable to that of commercial PF resin when viscosity was measured at a constant shear rate of 1000 s⁻¹ and at a temperature of 25° C. With 70-100% of phenol replaced by lignin, the formulated lignin-based phenolic resins have properties relatively similar to commercial PF resins. Such high-performance lignin-based resins suitably have a viscosity in a range of 200-1500 cP (0.2-1.5 Pa*s), 300-1200 cP (0.3-1.2 Pa*s), or 400-900 cP (0.4-0.9 Pa*s) measured at a constant shear rate of 1000 s⁻¹ and at a temperature of 25° C. Similarly, lignin-based resins according to the disclosure suitably have a solids content (e.g., resin reaction product in the aqueous reaction mixture, such as at the completion point) in a range of about 15-45 wt. %, 20-40 wt. %, or 25-35 wt. %.

By incorporating these various techniques, it was observed that essentially any commercially available lignin could be used to form an LF resin with good properties. For example, even commercially available kraft softwood and organosolv wheat straw, which do not have as many reactive phenolic hydroxyl groups as a corn stover lignin, could be used formulate a lignin-based phenolic adhesive. As illustrated in the examples below, a formulated lignin-based phenolic adhesive in which 100% of petroleum-based phenol was replaced with kraft softwood lignin had significantly higher dry adhesion strength (4.6 MPa) than a commercial phenol-formaldehyde (PF) adhesive (3.4 MPa).

### Adhesive Composition

An adhesive composition according to the disclosure is generally formed from an aqueous reaction mixture including water, a lignin, and at least one aldehyde including formaldehyde. A base catalyst is added to the aqueous reaction mixture in a controlled manner to catalyze a condensation reaction between the lignin and the aldehyde while maintaining a viscosity of aqueous reaction mixture below a gelation point of the aqueous reaction mixture. A molar excess or aldehyde functional groups is used relative to aromatic or phenolic hydroxyl groups in the initial aqueous reaction mixture. For example, the molar ratio of aromatic hydroxyl groups to aldehyde functional groups (initially) in the aqueous reaction mixture can be in a range of 1:2 to 1:4 or 1:2 to 1:6, for example at least 1:2, 1:2.5, 1:3, or 1:3.5 and/or up to 1:3.5, 1:4, 1:4.5, 1:5, or 1:6. Alternatively or additionally, a molar ratio of aldehyde-reactive sites (or carbon atoms) to aldehyde functional groups (initially) in the aqueous reaction mixture can be about 1:2, for example in a range of 1:1.5 to 1:3.5, 1:1.6 to 1:3, or 1:1.7 to 1:2.5. The condensation reaction between the lignin and the aldehyde is continued while maintaining the viscosity of the aqueous reaction mixture below its gelation point until its completion point is reached and a corresponding resin reaction product is formed. At the completion point, at least some unreacted ortho-reactive carbon atoms remain, and at least some (unsubstituted) methylol functional groups and/or substituted methylol functional groups (when a higher aldehyde was added) have been formed by the condensation reaction and are present in the resin reaction product.

Plants, in general, are comprised of cellulose, hemicellulose, lignin, extractives, and ash. Lignin typically constitutes 15-35 wt. % of plant cell walls, is an amorphous aromatic polymer made of phenylpropane units (e.g., coniferyl alcohol, sinapyl alcohol, p-coumaryl alcohol). The lignin for use according to the disclosure includes aromatic hydroxyl groups and ortho-reactive carbon atoms relative to the hydroxyl groups, but can otherwise be obtained from a variety of sources and isolations method. For example, the lignin can be derived from one or more types of biomass such as hardwoods, softwoods, grasses (e.g., agricultural residues), annual crops (e.g., straw, wheat straw), etc. Similarly, the lignin can be isolated from an extraction process such as Kraft extraction, soda extraction, organosolv extraction, enzymatic hydrolysis extraction, ionic liquid, extraction, and sulfite extraction.

In various embodiments, the lignin, prior to condensation reaction and/or incorporation into the aqueous reaction mixture, can be selected such that it has one or more structural features related to the molecular weight and/or weight distribution of its polymer chains, chemical structure and/or amount of its hydroxyl groups, chemical structure and/or amount of its ortho-reactive carbon sites. For example, in an embodiment, the lignin can have a molecular weight in a range of 500 to 50000, 1000 to 50000, 500 to 20000, or 3000 to 5000. In an embodiment, the lignin can have a polydispersity in a range of 1.2 to 10, 1.2 to 5, or 2 to 4. In an embodiment, the lignin can have an aliphatic hydroxyl content in a range of 1 to 5 mmol/g, 1 to 4 mmol/g, or 1 to 3 mmol/g. In an embodiment, the lignin can have a phenol hydroxyl content in a range of 1 to 6 mmol/g, 2 to 6 mmol/g, or 3 to 6 mmol/g. In an embodiment, the lignin can have a total hydroxyl content in a range of 3 to 9 mmol/g or 4 to 7 mmol/g. In an embodiment, the lignin can have a weight-average molecular weight of 2000 or less, or 5000 or less. In an embodiment, the lignin can have a polydispersity of 2.0 or less, or 3.0 or less. In an embodiment, at least 50% or at least 60% of the aromatic hydroxy groups in the lignin have at least 1 ortho-reactive carbon relative to the hydroxy group (e.g., 1 or 2 ortho-reactive carbons).

Lower molecular weights and low polydispersities are desirable to promote access to and reactivity of the aromatic hydroxy groups of the lignin, but lignin with any molecular weight and/or polydispersity can be used. Suitably, the weight-average molecular weight (M W) is at least 500, 800, or 1200 and/or up to 1000, 1200, 1500, 2000, 5000, or 10000, but higher values are possible. Similarly, the polydispersity (Mw/Mn, where Mn is the number-average molecular weight) is at least 1.2, 1.3, 1.4, or 1.5 and/or up to 1.5, 1.8, 2.0, 3.0, or 4.0, but higher values are possible.

Likewise, a lignin having aromatic hydroxy groups with available ortho-reactive carbon atoms adjacent to the hydroxy group on the lignin phenolic residue is suitable for the condensation reaction with the aldehyde groups. The carbon atoms in the phenolic ring and adjacent to the hydroxy group are particularly suitable for condensation reaction with aldehydes when they contain a hydrogen atom attached to the ring (e.g., instead of a methoxy or other alkoxy or blocking group). A lignin phenolic residue with two ortho-reactive carbon atoms generally corresponds to a hydroxyphenyl residue, a lignin phenolic residue with one ortho-reactive carbon atom generally corresponds to a guaiacyl residue, and a lignin phenolic residue with zero ortho-reactive carbon atoms generally corresponds to a syringyl residue. Suitably, at least 60, 70, 80, 85, 90, or 95% and/or up to 90, 95, 98, or 100% of the aromatic hydroxy groups in the lignin have 1 or 2 ortho-reactive carbon atoms. Alternatively or additionally, at least 10, 20, 30, 40, 50, 60, 70, or 80% and/or up to 40, 60, 80, 90, or 100% of the aromatic hydroxy groups in the lignin have 1 ortho-reactive carbon atom. Alternatively or additionally, at least 10, 20, 30, 40, 50, 60, 70, or 80% and/or up to 40, 60, 80, 90, or 100% of the aromatic hydroxy groups in the lignin have 2 ortho-reactive carbon atoms. The relative distribution of hydroxyphenyl, guaiacyl, and syringyl residues in a lignin sample can be controlled or selected according to the method used to extract the lignin from a biomass sample. The total aromatic hydroxy content (or phenolic hydroxyl content) of the lignin suitably is in a range of 2 to 5 mmol/g or 1 to 6 mmol/g. In an embodiment, the lignin can have a phenol hydroxyl content of at least 1, 1.5, 2, 2.5, or 3 mmol/g and/or up to 2, 2.5, 3, 4, 5, or 6 mmol/g.

An aldehyde reactant can be generically represented by R—CHO. The R group can include one or more aldehyde groups itself for the di- or higher aldehydes according to the disclosure (e.g., R is CHO for glyoxal). Similarly, the R group can be an alkyl group for a monoaldehyde, for example where R is CH 3 for acetaldehyde, and R is H for formaldehyde. In embodiments, aldehyde reactant in the aqueous reaction mixture can include formaldehyde alone or in combination with one or more higher aldehydes having at least 2 carbon atoms and at least 1 aldehyde functional group (—CHO). In various embodiments, the higher aldehyde can have 2 to 50 carbon atoms and has 1 to 4 or 2 to 4 aldehyde functional groups. Suitably, the higher aldehyde has at least 2, 4, 6, 8, or 10 carbon atoms and/or up to 4, 6, 8, 10, 20, 30, 50, or more carbon atoms. Alternatively or additionally, the higher aldehyde can have 1, 2, 3, 4, or more aldehyde groups. In an embodiment, the higher aldehyde is an at least di-functional aldehyde (i.e., having 2 or more aldehyde groups). Examples of suitable higher aldehydes include glyoxal (C₂ dialdehyde), glutaraldehyde (C₅ dialdehyde), gossypol (C₃₀ polyaromatic dialdehyde), oxidized starch (polymeric polyaldehyde), etc.

In some embodiments, the aqueous reaction mixture is free from at least one of phenol and/or higher aldehydes, for example as originally provided or prior to condensation reaction. The resin and adhesive according to the disclosure preferably uses complete replacement of phenol (P) with lignin (L), to provide an LF analog to a conventional PF resin with biobased reactants. Suitably, the aqueous reaction mixture contains less than 10, 5, 2, 1, or 0.1 wt. % of phenol and/or higher aldehydes, whether individually or combined. Alternatively or additionally, the adhesive composition (e.g., crosslinked or uncrosslinked) can similarly contain less than 10, 5, 2, 1, or 0.1 wt. % of phenol units and/or higher aldehyde units (i.e., as resulting condensation units in the reaction product), whether individually or combined.

In other embodiments, the higher aldehydes (A) can be at least partial replacements for the conventional formaldehyde (F) components. For example, at least 5, 10, 20, 30, 40, 50, 60, 70, 80, or 90% and/or up to 10, 20, 30, 40, 50, 60, 70, 80, 90, or 95 wt. % of the aldehyde groups in the initial aqueous reaction mixture can be from a formaldehyde reactant, such as where at least 5, 10, 20, 30, 40, 50, 60, 70, 80, or 90% and/or up to 10, 20, 30, 40, 50, 60, 70, 80, 90, or 95 wt. % of the aldehyde groups in the initial aqueous reaction mixture can be from aldehyde(s) having at least 2 carbon atoms and having at least 1 or at least 2 aldehyde functional groups. Alternatively or additionally, the adhesive composition (e.g., crosslinked or uncrosslinked) can similarly contain at least 5, 10, 20, 30, 40, 50, 60, 70, 80, or 90% and/or up to 10, 20, 30, 40, 50, 60, 70, 80, 90, or 95 wt. % formaldehyde units, and at least 5, 10, 20, 30, 40, 50, 60, 70, 80, or 90% and/or up to 10, 20, 30, 40, 50, 60, 70, 80, 90, or 95 wt. % aldehyde units from aldehyde(s) having at least 2 carbon atoms and having at least 1 or at least 2 aldehyde functional groups. In other embodiments, at least 20, 30, 40, 50, 60, or 70% and/or up to 60, 70, 80, 90, or 95% of the aldehyde groups in the initial aqueous reaction mixture can be from a formaldehyde reactant, such as where at least 5, 10, 20, 30, or 40% and/or up to 30, 40, 50, 60, 70, or 80% of the aldehyde groups in the initial aqueous reaction mixture can be from aldehyde(s) having at least 2 carbon atoms and having at least 1 or 2 aldehyde functional groups.

In other embodiments, minor amounts of phenol (P) can be included in the aqueous reaction mixture to complement the lignin (L) and provide a portion of the ortho-reactive carbon sites for resin formation and eventual crosslinking/curing in the adhesive. For example, at least 70, 75, 80, 85, 90, or 95% and/or up to 80, 90, 95, 98, 99, or 100% of the aromatic hydroxyl groups in the initial aqueous reaction mixture can be from the lignin. Alternatively or additionally, the lignin amount can be at least 70, 75, 80, 85, 90, or 95 wt. % and/or up to 80, 90, 95, 98, 99, or 100 wt. % relative to the combined amount of lignin and phenol in the initial aqueous reaction mixture. Similarly, at least 1, 2, 5, 10, 15, or 20% and/or up to 8, 10, 12, 15, 20, 25, or 30% of the aromatic hydroxyl groups in the initial aqueous reaction mixture can be from the phenol. Alternatively or additionally, the phenol amount can be at least 1, 2, 5, 10, 15, or 20 wt. % and/or up to 8, 10, 12, 15, 20, 25, or 30 wt. % relative to the combined amount of lignin and phenol in the initial aqueous reaction mixture.

In an embodiment, the molar ratio of aromatic hydroxy groups to aldehyde functional groups in the aqueous reaction mixture is less than 1, for example as originally provided or prior to condensation reaction. The resin formed can be a resole resin when there is an excess of aldehyde groups relative to aromatic hydroxy groups and a base catalyst. The ratio can be a molar ratio based on total aromatic hydroxy groups and total aldehyde reactants. A suitable lignin:aldehyde ratio (or aromatic hydroxy group:aldehyde ratio) can be in a range of 1:2 to 1:4 or 1:2 to 1:6, for example at least 1:2, 1:2.5, 1:3, or 1:3.5 and/or up to 1:3.5, 1:4, 1:4.5, 1:5, or 1:6. The base catalyst is not particularly limited, and sodium hydroxide is conveniently used a low-cost catalyst and means to solubilize the lignin in the aqueous reaction mixture.

In an embodiment, a molar ratio of aldehyde-reactive sites (or carbon atoms) to aldehyde functional groups (initially) in the aqueous reaction mixture is about 1:2, for example as originally provided or prior to condensation reaction. A suitable aldehyde-reactive site (or reactive carbon atom):aldehyde ratio can be in a range of 1:1.5 to 1:3.5, 1:1.6 to 1:3, or 1:1.7 to 1:2.5, for example at least 1:1.5, 1:1.6, 1:1.7, 1:1.8, 1:2, or 1:2.2 and/or up to 1:1.8, 1:2, 1:2.2, 1:2.5, 1:2.8, 1:3, 1:3.2, 1:3.5, or 1:4.0. The number of aldehyde-reactive sites (or carbon atoms) contributed by lignin can be determined using ³¹P NMR for lignin to determine the number and character of phenolic hydroxyl groups in the lignin, and then using a weighting factor of 2 for H-lignin residues (i.e., which include two ortho-reactive carbon atoms as aldehyde-reactive sites), and a weighting factor of 1 for G-lignin residues (i.e., which include one ortho-reactive carbon atom as an aldehyde-reactive site). The number of aldehyde-reactive sites (or carbon atoms) contributed by phenol is 3 times the molar amount of phenol, when present (i.e., including two ortho-reactive and one para-reactive carbon atoms). The total number of aldehyde-reactive sites in the (initial) in the aqueous reaction mixture can be represented by sum of the contributions from all lignin(s) present and any phenol present. The total number of aldehyde groups in the (initial) in the aqueous reaction mixture can be represented by sum of the contributions from formaldehyde (i.e., 1 aldehyde group per mole) and any higher aldehydes present (e.g., 1, 2, or more aldehydes group per mole).

Adding the catalyst in a controlled manner can generally include selecting a catalyst concentration, adding the catalyst batchwise (e.g., in 2, 3, 4, or more batch additions) or continuously over time, etc. in a manner that promotes the rate of the condensation reaction, but which prevents the condensation reaction from proceeding too rapidly in a manner that would cause gelation via excessive crosslinking during resin formation. This promotes reaction and higher conversion of a larger proportion of the lignin and aldehyde reactants. Without control of the reaction rate, it is possible for a relatively smaller fraction of the lignin and aldehyde reactants to rapidly react, crosslink, and gel, which in turn prevents further reaction of other ortho-reactive carbon atoms and unreacted aldehyde groups in the reactants (e.g., monomers, short oligomers, etc.). This results in low overall reactant conversion and/or a reaction product that is not suitable for use as an adhesive.

In an embodiment, the method further includes adding the aldehyde reactants in a controlled manner to advance the condensation reaction between the lignin and the aldehyde while maintaining a viscosity of aqueous reaction mixture below a gelation point of the aqueous reaction mixture. The aldehyde reactants, for example formaldehyde alone or in combination with higher aldehydes, are added to the aqueous reaction mixture in the presence of at least some base catalyst to catalyze the condensation reaction. For example, an initial step of providing the aqueous reaction mixture can include adding the aldehyde reactants in a controlled manner to an aqueous solution containing the water, the lignin, and base catalyst to begin the condensation reaction. Subsequent or concurrent addition of further base catalyst can be performed to further catalyze the condensation reaction as a controlled addition of the base catalyst. Similar to the catalyst, adding the aldehyde reactants in a controlled manner can generally include selecting an aldehyde concentration, adding the aldehyde batchwise (e.g., in 2, 3, 4, or more batch additions) or continuously over time, etc. in a manner that promotes the rate of the condensation reaction, but which prevents the condensation reaction from proceeding too rapidly in a manner that would cause gelation via excessive crosslinking during resin formation. This similarly promotes reaction and higher conversion of a larger proportion of the lignin and aldehyde reactants, while limiting or preventing crosslinking and gelation.

Suitably, the resin reaction product is not crosslinked at the completion point. Thus, while aldehyde groups and ortho-reactive carbon atoms have reacted to form (unsubstituted or substituted) methylol or alkylol groups at the ortho sites of the aromatic hydroxyl groups in the lignin, a networked or crosslinked thermoset polymer with (unsubstituted or substituted) methylene, alkylene, or glyoxylene groups linking ortho sites of two lignin aromatic groups has not yet formed. In the context of a generic aldehyde reactant represented by R—CHO, the (unsubstituted or substituted) methylol groups present at the completion point and linked to the ortho sites are correspondingly represented by —CHR—OH. Aldehyde groups in R could remain as aldehyde groups at this point, and/or aldehyde groups in R could also react with other ortho sites to form additional substituted methylol groups. The (unsubstituted or substituted) methylene groups present after curing/crosslinking (and preferably absent at the completion point) and linking two ortho sites are correspondingly represented by —CHR—. Although the (unsubstituted or substituted) methylene groups are formed mainly during crosslinking step, they can be formed in the condensation step of the resin synthesis to some extent (e.g., increasing the molecular weight as the resin reaction proceeds), but not to an extent that would cause gelation or substantial crosslinking. As used herein, the condensation reaction for the initial resin formation can include (1) addition of the aldehyde reactant to reactive ortho sites to form (unsubstituted or substituted) methylol or alkylol groups as well as (2) some water elimination/formation as (unsubstituted or substituted) methylol or alkylol groups react with other ortho sites to form a small degree of (unsubstituted or substituted) methylene groups that link aromatic units but which do not cause gelation or otherwise significantly crosslink the resin reaction product. Subsequent continuation of the condensation reaction during crosslinking or curing of an adhesive formulation generally continues the water elimination/formation reaction to form larger degree of (unsubstituted or substituted) methylene groups that result in a crosslinked or networked adhesive product. Aldehyde groups originally in R could have been converted to additional substituted methylene groups, and/or could have reacted with functional groups on a (wood) substrate or filler during curing. A reaction product that has passed the completion point and begun to crosslink is generally insoluble in the aqueous reaction medium and can be identified by solids (e.g., precipitate) in the reaction medium. Accordingly, the aqueous reaction medium is suitably substantially free from solid or precipitate material at the completion point (e.g., less than 0.1 or 0.01 wt. % solids not dissolved or otherwise in solution).

The condensation reaction can proceed both during and after catalyst addition, and the condensation reaction is controlled to avoid gelation during both phases. The completion point reflects a point during the reaction at which a substantial amount of the aldehyde groups and ortho-reactive carbon atoms have reacted to form (substituted) methylol groups at the ortho sites of the aromatic hydroxyl groups in the lignin, but there has not been any substantial crosslinking. At least some ortho-reactive carbon atoms remain at the completion point and are available for further reaction during curing. For example, the (unsubstituted or substituted) methylol groups can react during curing with other ortho-reactive carbon atoms to form the (unsubstituted or substituted) methylene groups linking adjacent aromatic groups. Any remaining aldehyde groups can react during curing with a substrate functional group (e.g., lignocellulosic group in a wood substrate), a filler functional group (e.g., for a lignocellulosic or polysaccharide filler), and/or other ortho-reactive carbon atoms in lignin moieties. The completion point can represent a point at which the condensation reaction is terminated/halted, for example by freezing or otherwise cooling the aqueous reaction mixture containing the partially reacted resin, such as for storage until subsequent use as a resin to form an adhesive. The completion point also can represent a point at which other adhesive/glue formulation components are added to the aqueous reaction mixture containing the partially reacted resin for further curing and adhesive formation.

A variety of suitable reaction conditions (e.g., time, temperature, or pressure) for forming the adhesive composition in its non-crosslinked (or uncured) resin state are possible as long as the reaction is monitored and controlled to avoid gelation. For example, the resin reaction product can be formed at a reaction temperature in a range from 40° C. to 95° C. or 65° C. to 85° C. while avoiding gelation and crosslinking. The reaction temperature for the initial condensation reaction to form the resin reaction product is not particularly limited, for example being at least 40, 50, 60 or 65° C. and/or up to 70, 80, 85, 90, or 95° C. The reaction pressure is suitably atmospheric pressure, for example 0.8 to 1.2 bar or 0.9 to 1.1 bar. The reaction time can be selected as desired and in view of the temperature and pressure conditions, but it typically can range from about 1-2 hr or 1-4 hr for common reaction conditions. Suitably, the reaction conditions are controlled such that substantially all of the initial aldehyde reactant has reacted to form at least one corresponding unsubstituted or substituted methylol group at an ortho-reactive site, but it is possible that at least some pendant (unreacted) aldehyde groups remain. Similarly, some unreacted formaldehyde can remain at the completion point. For example, a formaldehyde molecule having reacted with one ortho-reactive carbon will form one unsubstituted methylol group (—CH₂—OH) attached to the base aromatic or phenolic unit on the lignin. Likewise, a glyoxal molecule having reacted with one ortho-reactive carbon will form one substituted methylol group and retain one unreacted aldehyde group (—CH(CHO)—OH). Similarly, a glyoxal molecule having reacted with two ortho-reactive carbons will form two substituted methylol groups and have no remaining unreacted aldehyde groups. For example, at the completion point, at least 90, 95, 98, 99, or 99.9% of the initial aldehyde (e.g., on a weight or molar basis) has reacted to form at least one corresponding unsubstituted or substituted methylol group, in particular while avoiding cross-linking.

The non-crosslinked resin reaction product can be cured or crosslinked using methods and additional additives as generally known in the art for phenol-formaldehyde resins. For example, one or more adhesive components can be added to the resin reaction product or to the aqueous reaction mixture at or after the completion point. Examples of suitable adhesive components include fillers or biofillers, further catalyst, and/or further water. After the addition of the additional adhesive components, the condensation reaction is continued between remaining unreacted ortho-reactive carbon atoms and the unsubstituted or substituted methylol groups in the resin reaction product, thereby forming a crosslinked adhesive composition (e.g., networked or otherwise cured product). As described above, the unsubstituted or substituted methylol groups result from the initial condensation reaction between aldehyde groups of the aldehyde reactant and the ortho-reactive carbon atoms of the lignin reactant. During the curing portion of the condensation reaction, any unreacted aldehyde functional groups also can react, for example by reacting with a substrate, reacting to form further unsubstituted or substituted methylol groups (e.g., which can in turn condense to form a crosslink), etc.

A variety of suitable reaction conditions (e.g., time, temperature, or pressure) for curing or crosslinking the adhesive composition are possible. For example, continuation of the condensation reaction for curing can be performed at a reaction temperature in a range from 100° C. to 200° C., 120° C. to 180° C., or 130° C. to 180° C. while crosslinking. The reaction temperature for the subsequent condensation reaction to form the cured/crosslinked reaction product is not particularly limited, for example being at least 100, 110, 120, 130, or 140° C. and/or up to 150, 160, 170, 180, 190, or 200° C. The curing reaction is typically performed under pressure, for example in a press with the adhesive composition being cured between two substrates. For example, the curing pressure can be at least 8, 10, 12, or 14 bar and/or up to 16, 18, or 20 bar. The curing reaction time can be selected as desired and in view of the temperature and pressure conditions, but it typically can range from about 1-10 min for common curing conditions. Suitably, the reaction conditions are controlled such that there are substantially no remaining unreacted aldehyde groups. For example, in the crosslinked adhesive composition, the is suitably not more than 2, 1, 0.5, 0.2, or 0.1% free aldehyde (e.g., on a weight or molar basis), for example relative to the initial aldehyde used in the reaction.

As described below, the curing or crosslinking of the adhesive composition can be performed when the resin composition is in contact with one or more substrates (e.g., two or more substrates to be joined by the final cured adhesive), for example a wood or other substrate to form a corresponding article.

In an embodiment, the adhesive composition can include any suitable organic or inorganic filler or additive, which can be included to improve one or more of mechanical properties, optical properties, electrical properties, oil-resistance properties, and water-resistance properties of the final composition after curing or crosslinking to a completion point. The fillers or additives can be added to the adhesive composition prior to curing, for example being dispersed, dissolved, etc. in a non-crosslinked, uncured, or incompletely crosslinked/cured resin composition. In some embodiments, the fillers can include biobased fillers, for example polysaccharides such as starches, and/or lignocellulosic biomass such as woody fibers (e.g., wood flour, alder bark, etc.). The fillers can perform a variety of functions, for example providing a thickener for the adhesive composition prior to curing, an absorbent for excess water in the adhesive composition, a mechanical reinforcement for the cured adhesive composition, etc. In some embodiments, reactive functional groups (e.g., hydroxy groups) on the biobased fillers can react with remaining aldehyde groups during curing. Examples of other suitable fillers or additives include nanoclay, graphene oxide, graphene, silicon dioxide (silica), aluminum oxide, diatomaceous earth, cellulose nanocrystals, carbon nanotubes, titanium dioxide (titania), and combinations or mixtures thereof. In addition, the fillers can include biocides, pigments, dyes, a thermoplastic material, or a combination thereof. The fillers, whether organic, biobased, inorganic, etc. can be collectively or individually included in the range from 0.01 wt. % to 10 wt. % or 0.01 wt. % to 20 wt. %, for example in range from 1 wt. % to 5 wt. %, based on the total weight of the adhesive composition (e.g., combined weight of a networked, crosslinked polymerization product and all other additives combined).

### Article

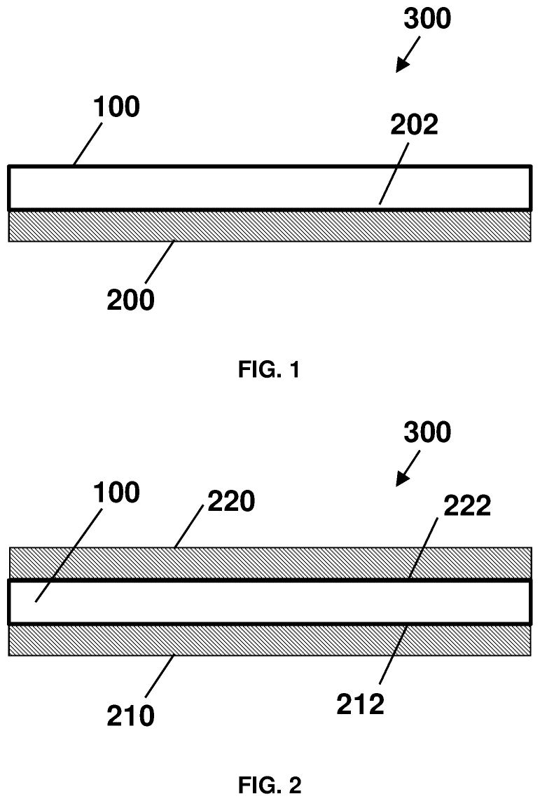

FIG. 1 illustrates an aspect of the disclosure in which an article 300 (e.g., coated article) includes a substrate 200 and the cured or crosslinked adhesive composition 100 coated on a surface 202 of the substrate 200. The cured composition 100 can be in the form of a coating or film on an external, environment-facing surface 202 of the substrate 200 (e.g., where the surface 202 would otherwise be exposed to the external environment in the absence of the composition 100). In this case, the cured composition 100 provides protection to the underlying substrate 200 (e.g., one or more of water-resistance, oil-resistance, mechanical strength, etc.). FIG. 2 illustrates an aspect of the disclosure in which an article 310 includes a first substrate 210, a second substrate 220, and the cured composition 100 coated on internal surfaces 212, 222 of the substrates 210, 220. In this case, the cured composition 100 can be in the form of an adhesive or bonding coating or film on the internal substrate surfaces, which coating or film joins the opposing substrates 210, 220. In another embodiment, the cured composition 100 can provide a polymeric matrix or binder in a composite product mixed with different type of natural or synthetic fibers, fillers, or substrates, for example as an engineered wood product such as plywood, particle board, fiber board, oriented strand board (OSB), etc.

The substrates are not particularly limited, and generally can be formed from any material(s) desired for protection, adhesion, or otherwise with the adhesive composition, in particular given the good, broad adhesive capabilities of the crosslinked adhesive composition. For example, the substrate can be a wood or other lignocellulosic material, a metal, plastic, a different thermoset material (e.g., a primer material; material other than the other than the adhesive composition), glass, fabric (or textile), or ceramic material. Examples of specific metals include steel, aluminum, copper, etc. Examples of specific plastics include polyvinyl alcohol (PVOH), ethylene vinyl alcohol (EVOH), polyethylene terephthalate (PET), polypropylene (PP), polyethylene (PE), polylactic acid (PLA), starch, chitosan, etc. In an embodiment, the substrate can be in the form of a three-dimensionally printed substrate, whether formed from a polymeric/plastic material or otherwise. Suitable wood materials can be any type of wood commonly used in home, office, and outdoor settings. Suitable glass materials can be those used for building windows, automobile windows, etc. In some embodiments, the substrate is a top layer of a coating or series of coatings on a different underlying substrate. For example, the coated article can include a substrate material as generally disclosed herein, one or more intermediate coatings on the substrate (e.g., an epoxy coating, an acrylic coating, another primer coating, etc.), and the crosslinked adhesive composition on the one or more intermediate coatings as the final, external coating on the coated article.

The cured or crosslinked adhesive composition can have any desired thickness on the substrate(s). In common applications, the crosslinked adhesive composition has a thickness ranging from 0.010 μm to 500 μm, for example at least 0.01, 10, 20, 50, or 100 μm and/or up to 200, 500 μm. Typical cast coatings can have thicknesses of 10 μm to 100 μm. Typical spin coatings can have thicknesses of 0.05 μm or 0.10 μm to 0.20 μm or 0.50 μm. Multiple coating layers can be applied to substrate to form even thicker layers of the adhesive composition (e.g., above 500 μm or otherwise) if desired.

### EXAMPLES

The following examples illustrate the disclosed compositions and methods, but are not intended to limit the scope of any claims thereto.

### Examples 1-2

These examples illustrate that modifying the ratio of materials used in the formulation of resin and also changing the synthesis method can provide a resin with more desirable properties for the production of lignin-based adhesive. For example, the formaldehyde used in the manufacture of resole phenolic adhesives has two important functions. During the fabrication of the resin, this formaldehyde participates in the condensation reaction and joins the phenolic rings by forming methylene bridges. Also, the formed methylol groups and any free formaldehyde content, remaining in the resin synthesis step, lead to cross-linking between the oligomeric chains during the curing stage and forms a crosslinked product. Study of lignin structure and characterization of the produced resin properties demonstrated that crosslinking effectiveness can be increased with substantially increase relative aldehyde amounts for example with molar ratios of formaldehyde to lignin (phenolic hydroxy groups) increased to 3:1 or higher in the resin synthesis stage. Also, the process time was decreased so that more free formaldehyde remains to facilitate crosslinking during the curing step. Evaluations of the produced resin properties showed that the process changes reduced the viscosity of the resin; to compensate for this effect in the stage of adhesive formulation, more filler, and less water were used. The results of adhesion performance test showed a shear strength of 4.6 MPa for the modified adhesive formulation (Example 2), which is significantly greater than the original or previous stage adhesive with the shear strength of 3.8 MPa (Example 1) and a comparative phenol-formaldehyde adhesive with a shear strength of 3.4 MPa. The following table shows the adhesive formulation composition.

TABLE 1
Adhesive Formulation Composition

| | Example 1 | Example 2 |
|---|---|---|
| Component | (Original) | (modified) |
| Sodium Hydroxide | 3 | 3 |
| Alder Bark (Modal) | 6.5 | 7.5 |
| Wheat flour | 6.5 | 7.5 |
| Water | 18 | 16 |
| Formulated Lignin-Formaldehyde Resin | 66 | 66 |

In another aspect, this disclosure relates the way the adhesive is formulated. To obtain a homogeneous adhesive that has reproducible properties and performance, some changes were made in the method of formulating the adhesive.

In Example 1, the following procedure shows the old method for preparing the adhesive. First, 6.5% (all on the weight basis) wheat flour is dissolved in 18% of distilled water. Then 6.5% plywood extender (Modal) is added slowly to the wheat flour mixture while stirring with a glass rod. Next, a combination of 3% NaOH flake and 66% thawed LF resin is added to the pellet and stirred for 5 minutes using a high-speed mixer at 800 rpm until the mixture became homogenous. In this example, the addition of the plywood extender immediately after the wheat flour causes the dough to aggregate, which leads to the production of a heterogeneous adhesive that does not homogenize well even with a lot of stirring. The resulting shear strength of the adhesive was 3.8 MPa.

In Example 2 for the modified method of forming the adhesive, the flour is dissolved in water and after adding the mixture of resin and sodium hydroxide, plywood extender is added at the last step of adhesive formulation. Also, the addition of sodium hydroxide in granular form and its addition shortly afterwards prevents the proper dissolution of sodium hydroxide in the resin, and the pH of the adhesive produced is not high enough to result in good adhesion on the wood texture. In engineering wood product applications, the pH should be held relatively high to ensure that the reactivity is high enough to facilitate the curing process and consequently shorten the pressing time. Accordingly, in the modified adhesive preparation procedure, sodium hydroxide is crushed using a porcelain mortar and then added to the resin solution and is mixed for 30 minutes to ensure complete dissolution. The resulting LF adhesive formulation is a homogeneous adhesive that possesses reproducible performance. The resulting shear strength of the adhesive was 4.6 MPa.

Resin and Adhesive Characterization: The lignin, resin, and adhesives according to the disclosure can be characterized according to the following methods.

A ³¹P NMR method can be used for the quantitative determination of the phenolic (or aromatic) hydroxyl content of lignin. For this purpose, a mixture of 325 μL of anhydrous pyridine/deuterated chloroform (1.6:1, v/v) and 300 μL anhydrous dimethylformamide (DMF) is prepared, and 40 mg of oven-dried lignin is then dissolved in the prepared solution under stirring. Then 100 μL of cyclohexanol with a concentration of 22 mg/mL (in anhydrous pyridine and deuterated chloroform with a ratio of 1.6:1.0 (v/v)) is added to the mixture. Then 50 μL of chromium (III) acetylacetonate solution with a concentration of 5.6 mg/mL in the mixture of anhydrous pyridine and deuterated chloroform (1.6:1.0, v/v) is added. The cyclohexanol acts as an internal standard, and chromium (III) acetylacetonate as relaxation reagent. At the end, for tagging hydroxyl groups during ³¹P NMR analysis, 100 μL of phosphitylating reagent (2-chloro-4,4,5,5-tetramethyl-1,3,2-dioxaphospholane (TMDP)) is added to the mixture. The sample is run in an AGILENT DDR2 500 MHz NMR spectrometer, equipped with 7600AS, running VnmrJ 3.2A, with a pulse delay of 5 s (relaxation time), and 128 scans, or equivalent. The evaluation of various hydroxyl groups content is based on the ratio of internal standard peak area to integrated areas attributed to various hydroxyl groups.

The solid (or non-volatile) content of a resin sample can be measured with five replicates for each sample, according to ASTM D4426-01. Accordingly, aluminum pans are placed in a furnace at 270° C. for about 1 min to burn off any excess oils left behind during manufacturing. The pans are cooled to room temperature and weighed. Then 1 g of the resin is measured in each labeled pan and placed in an oven for 105 mins at 125° C. In the next step, using a desiccator, samples are cooled to room temperature and then weighed. The solid content is determined based on mass difference and expressed on a wt. % basis.

The pH of resin and adhesive samples can be measured using a Mettler Toledo S220 digital pH meter at room temperature after stirring the samples for 10 s at 400 rpm.

The viscosity of the formulated resin and adhesive samples can be measured using a DISCOVERY HR-1 hybrid rheometer (TA Instruments) at a constant temperature of 23° C. or 25° C. and a shear rate of 1000 s⁻¹.

The gelation time of a resin sample can be measured using the manufacturer's recommended procedure. Briefly, the DISCOVERY HR-1 hybrid rheometer (TA Instruments) with 40 mm parallel plates are used at constant temperature of 25° C. A dynamic time sweep method is selected and an oscillation-time mode is set. After running the instrument with an appropriate amount of resin, the crossover of storage and loss modulus curves provides the gelation point.

The free formaldehyde content of a resin sample can be measured using the hydroxylamine hydrochloride method. When formaldehyde reacts with hydroxylamine hydrochloride, hydrochloric acid is formed, and a potentiometric titration is used to determine the amount of produced hydrochloric acid. For determining free formaldehyde content, 5 g of resin is weighed and added to 100 ml distilled water. Then, using 0.1N HCl, the pH is adjusted to 4.0 while stirring the solution at 350 rpm. Then 20 ml of 10 wt. % hydroxylamine hydrochloride is added to the resin solution. After 5 minutes, the solution is titrated to a pH of 4.0 using 0.1N NaOH. The free formaldehyde content is then calculated as [Vml (NaOH)×N(NaOH)×3.003]/[weight of resin sample (g)].

Alkalinity is different from pH in the sense that alkalinity shows the ability of a solution to neutralize acids and depends on the total number of anions present in the solution, while the pH value reflects the acidic or basic strength of the solution. In either case, extreme pH or alkalinity values can adversely affect the mechanical performance of an adhesive, especially in the presence of moisture. The alkalinity of a sample can be measured according to the procedure recommended by Lorenz and Christiansen. Different amounts of resin or adhesive (2 to 10 g), based on the expected amount of NaOH in the resin or adhesive, are added to 100 ml distilled water. Then 0.1N Hydrochloric acid solution is used to titrate the solution to a pH of 3.5. The alkalinity measurement is based on the volume of hydrochloric acid and the amount of resin or adhesive being used, and it is expressed a % NaOH value: [Vml HCl used×0.4×100]/[weight of resin or adhesive sample (g)].

Lap shear strength can be evaluated to measure the adhesion strength of the produced adhesives under similar conditions as used by industry for manufacturing plywood. According to ASTM D5868-01, 0.10-0.12 g of the prepared adhesive is applied on one-fourth of a veneer sample surface (contact area: 25.4 mm×25.4 mm; veneer sizes: 25.4 mm×101.6 mm×5.6 mm), prepared using yellow southern pine wood. Ten replicates of each formulated adhesive are tested for shear strength testing. Using a hot press, two veneers are pressed at 175° C. under 1250 kPa or 1400 kPa for 4 min. An Instron 5565 universal testing machine with a loading rate of 0.5 in/min is used to measure the adhesion strength of the adhesive samples.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A method for forming an adhesive composition, the method comprising:
providing an aqueous reaction mixture comprising
water,
a lignin comprising aromatic hydroxyl groups and ortho-reactive carbon atoms relative to the hydroxyl groups, and
an aldehyde comprising formaldehyde;
wherein a molar ratio of aromatic hydroxyl groups to aldehyde functional groups in the aqueous reaction mixture is in a range of 1:2 to 1:4,
adding a base catalyst in a controlled manner to the aqueous reaction mixture, thereby catalyzing a condensation reaction between the lignin and the aldehyde while maintaining a viscosity of aqueous reaction mixture below a gelation point of the aqueous reaction mixture; and
continuing the condensation reaction between the lignin and the aldehyde to form a resin reaction product while maintaining the viscosity of aqueous reaction mixture below the gelation point of the aqueous reaction mixture until a completion point is reached, wherein, at the completion point, at least some unreacted ortho-reactive carbon atoms remain, at least some methylol functional groups have been formed by the condensation reaction, and the resin reaction product is not crosslinked.

2. The method of claim 1, wherein a molar ratio of aldehyde-reactive sites to aldehyde functional groups in the aqueous reaction mixture is in a range of 1:1.5 to 1:3.5.

3. The method of claim 1, wherein providing the aqueous reaction mixture comprises:
providing a lignin solution comprising the lignin in solution in the water at a pH value of at least 12; and
adding the aldehyde to the lignin solution to form the aqueous reaction mixture.

4. The method of claim 3, wherein the lignin solution contains an amount of water in a range of 100% to 150% of the minimum amount of water required to dissolve the lignin at the pH value of the lignin solution.

5. The method of claim 1, wherein:
the aqueous reaction mixture at the completion point has a viscosity in a range of 200 cP to 1500 cP measured at a constant shear rate of 1000 s⁻¹ and 25° C.; and
the aqueous reaction mixture at the completion point has a solids content in a range of 15 wt. % to 45 wt. %.

6. The method of claim 1, wherein the aqueous reaction mixture at the completion point contains 1 wt. % or less free (unreacted) formaldehyde.

7. The method of claim 1, comprising forming the resin reaction product at a reaction temperature in a range from 40° C. to 95° C. while avoiding gelation and cross-linking.

8. The method of claim 1, wherein the lignin is a kraft softwood lignin.

9. The method of claim 1, wherein the lignin is derived from a biomass selected from the group consisting of hardwoods, softwoods, grasses, and combinations thereof.

10. The method of claim 1, wherein the lignin is isolated from an extraction process selected from the group consisting of Kraft extraction, soda extraction, organosolv extraction, enzymatic hydrolysis extraction, ionic liquid, extraction, sulfite extraction, and combinations thereof.

11. The method of claim 1, wherein the lignin has at least one of the following properties:
a weight-average molecular weight of 2000 or less;
a polydispersity of 2.0 or less; and
at least 60% of the aromatic hydroxy groups have at least 1 ortho-reactive carbon relative to the hydroxy group.

12. The method of claim 1, wherein at least 60% of the aromatic hydroxy groups in the lignin have at least 1 ortho-reactive carbon relative to the hydroxy group.

13. The method of claim 1, wherein the lignin comprises aromatic ether groups and ortho-reactive carbon atoms relative to the ether groups.

14. The method of claim 1, wherein the aqueous reaction mixture is free from phenol and aldehydes having at least 2 carbon atoms and at least 1 aldehyde functional group (—CHO).

15. The method of claim 1, wherein the aqueous reaction mixture comprises a higher aldehyde having at least 2 carbon atoms and at least 1 aldehyde functional group (—CHO).

16. The method of claim 15, wherein the higher aldehyde has 2 to 50 carbon atoms and has 1 to 4 aldehyde functional groups.

17. The method of claim 15, wherein:
5% to 95% of the aldehyde functional groups in the aqueous reaction mixture are from the formaldehyde; and
5% to 95% of the aldehyde functional groups in the aqueous reaction mixture are from the higher aldehyde.

18. The method of claim 15, wherein:
40% to 80% of the aldehyde functional groups in the aqueous reaction mixture are from the formaldehyde; and
20% to 60% of the aldehyde functional groups in the aqueous reaction mixture are from the higher aldehyde.

19. The method of claim 1, wherein the aqueous reaction mixture comprises phenol.

20. The method of claim 19, wherein:
70% to 99% of the aromatic hydroxyl groups in the aqueous reaction mixture are from the lignin; and
1% to 30% of the aromatic hydroxyl groups in the aqueous reaction mixture are from the phenol.

21. The method of claim 1, wherein the resin reaction product has a pH value of at least 10.

22. The method of claim 1, wherein the resin reaction product has an alkalinity value in a range of 1.5% to 7%.

23. The method of claim 1, wherein the resin reaction product has gelation time in a range of 4 minutes to 30 minutes.

24. The method of claim 1, further comprising: adding the aldehyde aqueous reaction mixture in a controlled manner and in the presence of at least some base catalyst, thereby catalyzing a condensation reaction between the lignin and the aldehyde while maintaining a viscosity of aqueous reaction mixture below a gelation point of the aqueous reaction mixture.

25. The method of claim 1, wherein the molar ratio of aromatic hydroxyl groups to aldehyde functional groups (initially) in the aqueous reaction mixture is in a range of 1:3 to 1:4.

26. The method of claim 1, further comprising:
adding one or more adhesive components to the aqueous reaction mixture at or after the completion point, the adhesive components being selected from the group consisting of fillers, further catalyst, and further water; and
continuing the condensation reaction between remaining unreacted ortho-reactive carbon atoms and the methylol groups in the resin reaction product, thereby forming a crosslinked adhesive composition.

27. The method of claim 26, wherein at least one adhesive component is the further catalyst, and the further catalyst is present in an amount in a range of 2 wt. % to 6 wt. % after addition of the adhesive components.

28. The method of claim 26, wherein:
at least one adhesive component is the further catalyst, and the further catalyst is in solid form when added to the aqueous reaction mixture;
at least one adhesive component is the further water;
at least one adhesive component is a filler; and
the further water and the further catalyst are added to the aqueous reaction mixture separately from and before the filler.

29. The method of claim 26, comprising continuing the condensation reaction at a reaction temperature in a range from 100° C. to 200° C. while cross-linking.

30. The method of claim 26, comprising continuing the condensation reaction when the aqueous reaction mixture is in contact with one or more substrates.

31. The method of claim 4, wherein:
the molar ratio of aromatic hydroxyl groups to aldehyde functional groups in the aqueous reaction mixture is in a range of 1:2.5 to 1:3.5;
a molar ratio of aldehyde-reactive sites to aldehyde functional groups in the aqueous reaction mixture is in a range of 1:1.7 to 1:2.5;
the aqueous reaction mixture at the completion point has a viscosity in a range of 300 cP to 1200 cP measured at a constant shear rate of 1000 s⁻¹ and 25° C.;
the aqueous reaction mixture at the completion point has a solids content in a range of 20 wt. % to 35 wt. %;
the lignin comprises aromatic ether groups and ortho-reactive carbon atoms relative to the ether groups;
the lignin is derived from a biomass selected from the group consisting of softwoods; and
the resin reaction product has a pH value of at least 10.

32. The method of claim 31, further comprising:
adding adhesive components to the aqueous reaction mixture at or after the completion point, the adhesive components comprising fillers, further catalyst, and further water, wherein the further catalyst is present in an amount in a range of 3 wt. % to 6 wt. % after addition of the adhesive components; and
continuing the condensation reaction between remaining unreacted ortho-reactive carbon atoms and the methylol groups in the resin reaction product (i) at a reaction temperature in a range from 100° C. to 150° C. while crosslinking and (ii) when the aqueous reaction mixture is in contact with one or more wood substrates, thereby forming a crosslinked adhesive composition.

33. An adhesive composition formed by claim 1.

34. A crosslinked adhesive composition formed by claim 26.
